(19) United States
(12) Patent Application Publication
(10) Pub. No.: US 2008/0276189 A1
(43) Pub. Date: Nov. 6, 2008

(54) Method and system for themeable on-screen display

(76) Inventor: Thomas Dawson, Escondido, CA (US)

Correspondence Address: MURABITO, HAO& BARNES LLP, Third Floor, Two North Market Street, San Jose, CA, 95113, US

(21) Appl. No.: 11/799,515

(22) Filed: May 1, 2007

(51) Int. Cl. G06F 3/048

(52) U.S. Cl. 715/765

(57) ABSTRACT

A method of customizing an on-screen menu display. According to one embodiment, a plurality of selectable themes is provided and in response to a selection of one of the selectable themes, the graphical user interface is customized. According to one embodiment, the selectable themes provided are based on user's prior history and use (e.g., using a web cookie). Accordingly, various navigatible items, selectable items and related content may be customized and displayed to have the look and feel of the selected theme. Selectable themes may be a stilled image, animation, audio or a combination thereof. Accordingly, the on-screen display is customized based on the selected theme. In one embodiment, the selected theme and the configured on-screen display may be stored. Moreover, in one embodiment, an update for the selected theme may be automatically provided.

### TECHNICAL FIELD

Embodiments of the present invention relate to the field of electronics. More particularly, embodiments of the present invention relate to a method and system for on-screen television display.

### BACKGROUND ART

In general, electronic devices (e.g., televisions, play station portables (PSPs) and radios) are manufactured in large volumes. In order to reduce cost, electronic devices are made as generic as possible. As such, customizing electronic devices have been difficult.

In recent years, increasing use of electronic devices such as cellular phones, blackberrys, laptops, IPods and etc., to name a few, has led to minimal customization of these electronic devices. For example, cellular phones are now capable of limited customization for basic functions like the background images, color and ring tones.

In contrast, customizability of televisions, PSPs and radios has almost been none existent. In general, the graphical user interfaces that are displayed are generic and non-customizable. For example, some televisions have a “Menu” option where various selectable icons may be displayed. These selectable icons are very generic and usually represent simple boxes. As such, the “Menu” displays and other similar icons along with their information tend to be bland and generic.

Not only are current graphical user interfaces for television sets, radios and PSPs bland, but they lack customizability as well. For example, currently a user is unable to customize the graphical user interface based on the user's preferences. As such, graphical user interfaces used for television sets, radios and PSPs, to name a few, are uninteresting and non-engaging.

### SUMMARY

Accordingly, a need has arisen to provide a method for customizing graphical user interfaces for electronic devices (e.g., television sets, set-top-boxes, play station portables (PSPs) and radios, to name a few) based on a user preference. Moreover, a need has arisen to provide a graphical user interface that reflects a user preference and is more appealing and engaging to the user. It will become apparent to those skilled in the art in view of the detailed description of the present invention that the embodiments of the present invention remedy the above mentioned needs.

In one embodiment of the present invention, a plurality of selectable themes (e.g., sports, sci-fi, movie stars, musicians, etc.) can be displayed to the user. A user may select one of the selectable themes. In response to the selection, the theme may be downloaded to the user. As a result, various selectable and navigatible items as well as content may be customized based on the selected theme. Accordingly, various selectable and navigatible items as well as content may be customized in accordance with the selected theme in order to configure the graphical user interface to have the look and feel of the selected theme, thereby increasing the appeal of the interface with respect to the user.

For example, if the selectable theme is a baseball theme, then the selectable items (e.g., Menu icon) may be displayed as a base, a baseball, a baseball bat, or even various baseball players, to name a few. In one example, a user may be a San Francisco Giants fan. Accordingly, the user may select the SF Giants' theme. As a result, the background of the graphical user interface may have the SF Giants' logo and the colors may be orange and black. Moreover, the icons of the interface menus may be configured and displayed as different players, e.g., Barry Bonds. Consequently, the look and feel of the graphical user interface can be customized based on the user's preference. Accordingly, the graphical user interface is no longer bland, but rather interesting, engaging, more interactive and in accordance with the user's preference. Moreover, the theme may also deliver other theme-specific content such as advertisements and/or theme-specific programming for the user.

Moreover, selectable themes may be beneficial for customers as well as advertisers. For example, selectable themes may be implemented by the manufacturer at the behest of an advertising sponsor. Accordingly, the sponsor may use the TV menu system as means for product and service placement, thereby providing more exposure to the sponsor. The service may be provided free of charge to the customers. However, the usage of the selectable theme displaying the product and service placement may be tracked such that the sponsor can be charged based on the amount of time the product and service placement is active. As a result, the manufacturer gains a recurring revenue stream on sold products.

More specifically, an embodiment of the present invention pertains to a process of customizing an on-screen display including: providing a plurality of user selectable themes operable to configure the on-screen display; in response to a selection of one of the plurality of user selectable themes, configuring the on-screen display in accordance with the selected user selectable theme, wherein the configuring is operable to customize content and a plurality of user selectable items within the on-screen display; and rendering the configured on-screen display theme may be downloaded to the device via the broadcast channel.

According to one embodiment, the selected user selectable theme may be stored. Similarly, in one embodiment, the configured on-screen display may be stored. In accordance with one embodiment, the selected user selectable theme may be automatically updated. The update content of the theme may be based on various criteria. For example, in one embodiment a basketball selectable theme may be updated during March madness to reflect NCAA basketball games and themes and related content.

Moreover, in one embodiment the providing the theme is based on determining a user preference in accordance with at least one prior user interaction. In one embodiment, the process may further include receiving the plurality of user selectable themes. In one embodiment, the plurality of selectable themes is for a television set or set-top-box. Similarly, the plurality of selectable themes may be for a graphical user interface for a radio or play station portables (PSPs). In one specific embodiment, the theme may be applied to the menu items of a cross bar user interface for a television or set-top-box.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an exemplary flow diagram in accordance with one embodiment of the present invention.

FIG. 2 shows an exemplary graphical user interface during navigation of menu items in accordance with one embodiment of the present invention.

FIG. 3 shows an exemplary graphical user interface during a selection of a selectable item in accordance with one embodiment of the present invention.

FIG. 4 shows exemplary customized icons during a navigation of items in accordance with one embodiment of the present invention.

FIG. 5 shows exemplary customized icons during a selection of a selectable item in accordance with one embodiment of the present invention.

FIG. 6 illustrates a general purpose wireless device that may serve as a platform for receiving and gathering data in accordance with embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from following discussions, it is appreciated that throughout the present invention, discussions utilizing terms such as “processing” or “creating” or “transferring” or “executing” or “determining” or “instructing” or “issuing” or “halting” or “clearing” or “accessing” or “aggregating” or “obtaining” or “selecting” or “providing” or “receiving” or “configuring” or “rendering” or “storing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### A Method and System for Themeable on-Screen Display

As discussed and presented above, there is a need to customize graphical user interfaces for various electronic devices (e.g., television, radio and play station portable (PSP) and etc.). Customizing and configuring a graphical user interface facilitates an engaging environment for a user to interact with their electronic devices. Moreover, customizing the graphical user interface eliminates the bland and generic operating environment while allowing a user to adapt the graphical user interface based on the user's preferences.

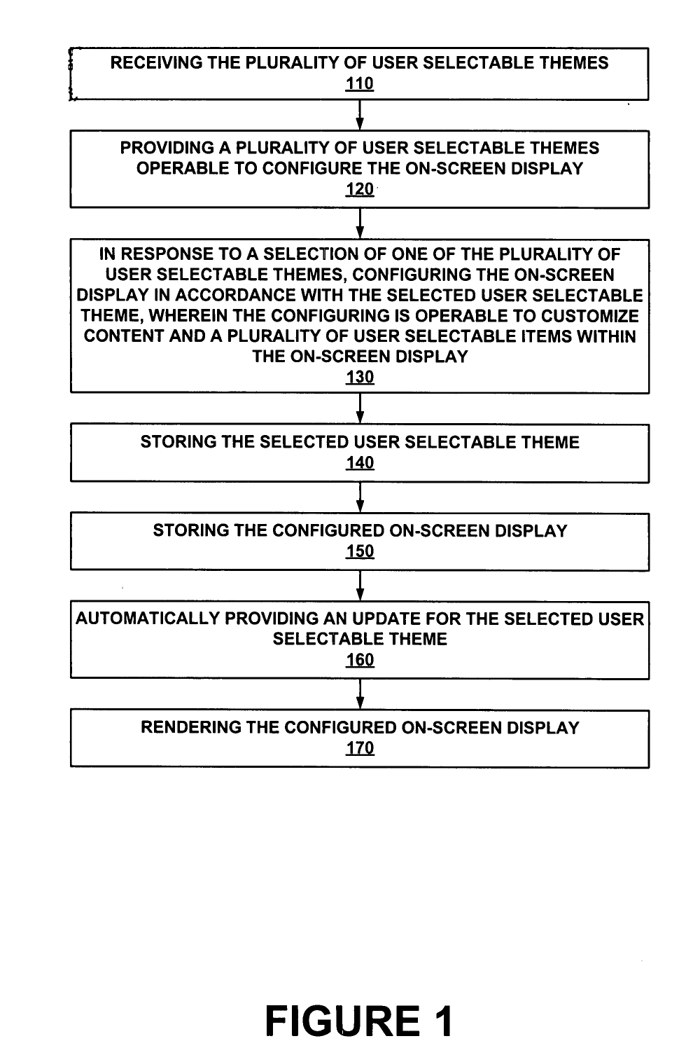

Referring now to FIG. 1, a flow diagram 100 in accordance with one embodiment of the present invention is shown. At step 110, a plurality of user selectable themes may be received by the electronic device (e.g., set-top-box, television, radio, PSP, etc.) and presented for user selection. A theme may be a user preferred theme. For example, a sci-fi fan may select a theme that resembles the user's favorite characters. A sport's fan may select a sport theme or may be more specific and select the user's favorite sport team. For example, if a user is a baseball fan then the user may select a theme for his favorite baseball team (e.g., San Francisco Giants). Similarly, a user whom is a movie buff may select a movie theme with his favorite actors and actresses and movies. It is appreciated that the themes mentioned are exemplary and should not be construed as limiting the scope of the present invention.

In one embodiment, the plurality of user selectable themes may be received through an Internet connection, through wireless device communication, through Cable and other similar broadcast means, to name a few. For example, when the electronic device is Internet Protocol Television (IPTV) operable, the device may be coupled to the Internet, thereby capable of receiving the plurality of selectable themes through the Internet.

It is appreciated that according to one embodiment, the plurality of user selectable themes may be provided on a memory component (e.g., a universal serial bus (USB) key). For example, the plurality of user selectable themes may be provided using a removable memory component or it may be pre-installed on the electronic device.

In one embodiment, the user's prior history and use may be used in order to determine the plurality of theme offerings. For example, based on the user's prior use and history of a television or set-top-box it may be determined that a user is a movie buff or a sport fan. Accordingly, the plurality of selectable themes that may be of an interest to the user may be directed to the user and other themes that are not of an interest to the user may be filtered out (e.g., home and garden theme). In one embodiment, a means similar to web cookies may be used to determine the user's prior history. Accordingly, the cookies may be used to determine possible themes that the user might find interesting. As such, theme offerings may be tailored based on user's history and thereby be user specific.

At step 120, the plurality of user selectable themes that are operable to configure the on-screen display, are displayed to the user. For example, a sci-fi theme, a sport theme and a movie theme may be displayed in a displayed list. It is appreciated that the display may be a plasma, a rear projection, a cathode ray tube (CRT), a liquid crystal display (LCD) or other similar displays. Accordingly, a user may select at least one of the plurality of user selectable themes.

At step 130, in response to the user selection of one of the themes, the on-screen display may be configured. It is appreciated that the selection may be performed by a point and click device (e.g., a mouse), a stylus, a remote, through operating various buttons, or voice commands, to name a few. It is appreciated that the method by which the theme is selected should not be construed as limiting the scope of the present invention.

The on-screen display is configured based on the selected user selectable theme. For example, if a sci-fi or if a baseball theme is selected, the graphical user interface is customized based on that theme. According to one embodiment, a plurality of user selectable items and content of the graphical user interface may be customized. For example, an icon representing “Menu” option may be represented by a baseball theme (e.g., Barry Bonds' picture may be superimposed on the icon) within a cross bar menu interface. Similarly, the background of the graphical user interface may be customized and configured based on the selected theme. For example, if a baseball theme is selected, the background may be a baseball glove. Similarly, the background may be the user's favorite ballpark (e.g., AT&T ballpark).

Accordingly, in one embodiment the graphical user interface superimposes the selected theme on a plurality of selectable and navigatible items (e.g., icons) along with their related content. Accordingly, bland icons are now more engaging based on the selected theme. As such, each icon, each navigatible item, content, etc., may be configured based on the selected theme.

In one embodiment,.the user selectable theme may have still images and/or animation. For example, in one embodiment not only the icons may be superimposed with the selected theme but in response to a selection of a selectable icon (e.g., selecting a channel) the resultant animation may be activated. For example, if the theme is a baseball theme, upon selecting a selectable icon, animation of a baseball bat swinging at the baseball may be displayed.

Referring still to FIG. 1, at step 140 the selected user selectable theme may be memory stored. Accordingly, the selected user selectable theme may be retrieved by accessing the memory. In one embodiment, at step 150 the configured on-screen display based on the selected theme may be stored. Accordingly, configuring the graphical user interface based on the selected theme, subsequent configuring is eliminated, thereby making the configuration and customization of the graphical user interface more efficient.

Optionally, at step 160 an update for the selected user selectable theme may be provided. For example, if the user selected theme is a sport theme then during March madness a new updated theme or content that reflects March madness may be provided. As a result, the themes are not only aligned with the user preference and selection but they also dynamically change over time based on current sports events, news events, etc. Similarly, if the user selected a movie theme, then during the Oscars the theme may be updated to reflect the result of the Oscars and the movies. A weather theme may be updated to reflect current weather pattern for the user's location.

At step 170, the configured on-screen display may be rendered. Accordingly, the configured graphical user interface now reflects the user preference based on the selected theme. As a result, the graphical user interface is no longer bland and generic but rather inviting, more interactive and based on the user preference.

It is appreciated that even though, customizing the graphical user interface is discussed in relation to still images and video animation, but they are equally applicable to audio customization as well. For example, navigating and selecting various items may be customizable to output an audio rendering based on the selected theme (e.g., sci-fi character). As such, customization may be of still images, animation and audio output or any combination thereof.

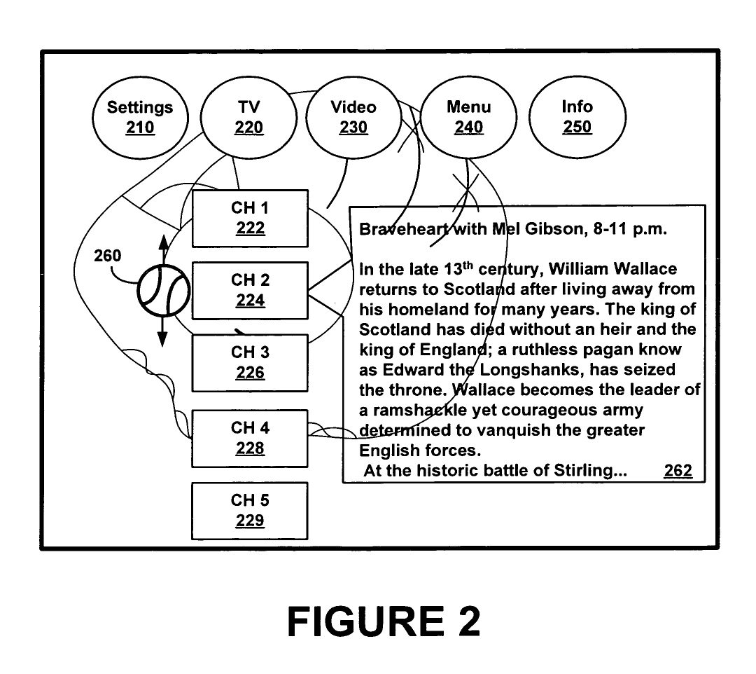

Referring now to FIG. 2, an exemplary on-screen graphical user interface during user navigation of items (e.g., with a cursor driven remote) in accordance with one embodiment of the present invention is shown. It is appreciated that the exemplary graphical user interface may be for a television set as shown. However, the graphical user interface may be for other electronic devices (e.g., radio, PSPs, etc.). As such, the exemplary graphical user interface for a television set is exemplary and should not be construed as limiting the scope of the present invention.

The graphical user interface may display various selectable and navigatible icons. For example, the graphical user interface may display “Settings” 210 where a user may set various options for the television set. In the background, an image of a baseball glove is shown. The graphical user interface may also have other selectable and navigatible icons, such as a TV 220, a Video 230, a Menu 240 and an Info 250 icons, to name a few. In this example, the icons 210, 220, 230, 240 and 250 are not customized but are rather generic. In response to a user navigating over the selectable and navigatible icons (e.g., TV 220), a plurality of additional navigatible and selectable icons may be displayed. For example, when a user selects or navigates to the TV 220 icon, various channel icons 222, 224, 226, 228 and 229 may be displayed in a cross bar display orientation.

In one embodiment, a navigation means such as a pointer or the key arrows of a remote control device may be used. However, instead of displaying the pointer as a cursor, the pointer may be configured and customized based on the selected theme. In this example, the selected theme is a baseball theme. As a result, the on-screen pointer may be displayed as a still image of a baseball 260 that allows the user to navigate between various navigatible icons (e.g., icons 222, 224, 226, 228, 229 and 210, 220, 230, 240 and 250). It is appreciated that in one embodiment, the configured pointer may be animated. For example, the baseball 260 may be animated as a spinning baseball.

It is appreciated that as the baseball 260 navigates through various icons, related information to the navigatible icon may be displayed. In this exemplary embodiment, as the baseball 260 navigates over icon 224, the information 262 related to Channel 2 is displayed. In one example, the displayed information may be in a form of a pop-up window, drop down menu or other similar methods. In this exemplary embodiment, the related information to the icon 224 represents content of the icon 224. For example, Channel 2 is showing “Braveheart” and it provides a short description of the content in window 262.

It is appreciated, that window 262 is shown as a generic window that is not displayed based on the selected theme. However, in other embodiment, any information such as the content window 262 may be customized based on the selected theme. It is further appreciated that the background of the graphical user interface may be customized based on the selected theme. In this exemplary embodiment, the background is a baseball glove in accordance with the selected theme (e.g., baseball theme).

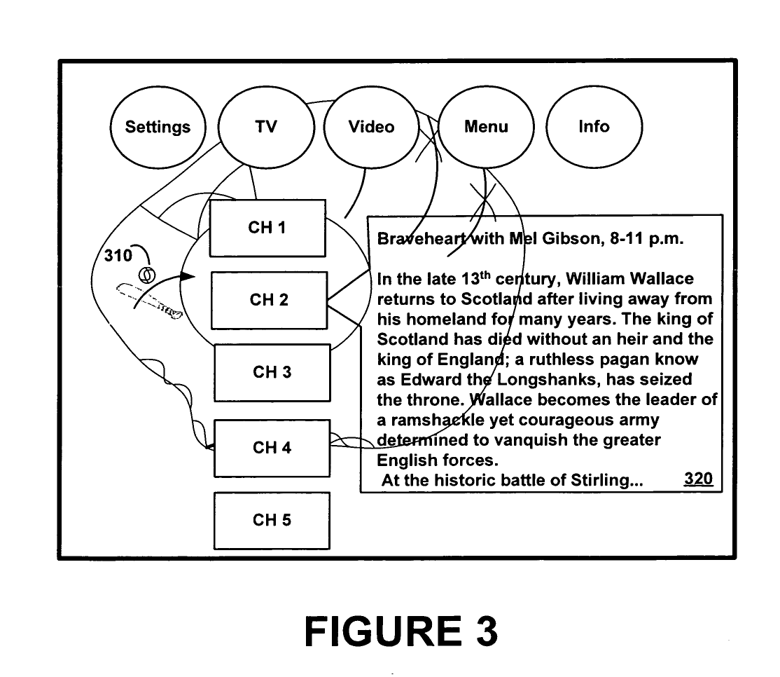

Referring now to FIG. 3, an exemplary graphical user interface during a selection of a selectable item in accordance with one embodiment of the present invention is shown. In this exemplary embodiment, the user selects Channel 2 for watching Braveheart. Accordingly, the baseball 260 may now become an animation of a baseball bat hitting the baseball 310 to reflect the user selection. In response to this selection, the content window 262 may be highlighted 320 in order to indicate that the channel has been selected.

It is appreciated that in other embodiments, other customizable configuration may be used. For example, instead of an animation of a baseball bat hitting a baseball 310, an actual clip of Barry Bonds hitting a home run may be displayed. Accordingly, the still images and animation described herein are exemplary and should not be construed as limiting the scope of the present invention.

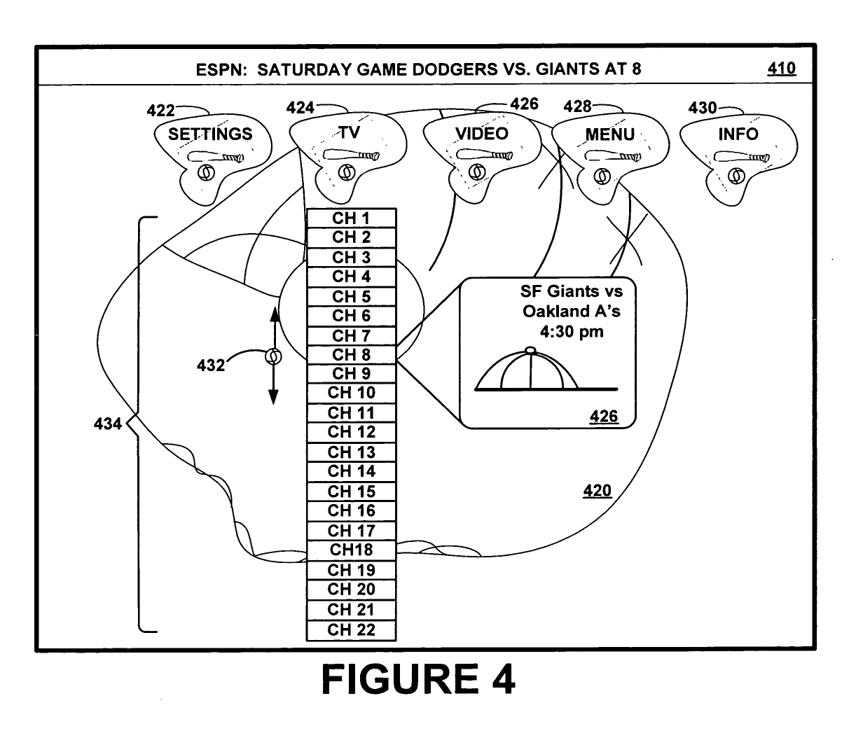

Referring now to FIG. 4, exemplary customized icons during a navigation of items in accordance with one embodiment of the present invention is shown. In this exemplary embodiment, the graphical user interface may be displayed in two portions, 410 and 420. Portion 410 may be used to display advertising information and content that may be related to the selected theme. For example, if a user selects a baseball theme, then advertising or news events related to the theme may be displayed to inform the user that Dodgers versus Giants game will be on Saturday or the game results of recently played games.

In one embodiment, the selectable theme and the amount of time advertising information and content is displayed in portion 410 may be tracked. The sponsor of the advertising may be charged based on the amount of time the advertising through display portion 410 is active. As a result, advertiser may be provided with more exposure via displaying product and service placement on the selectable theme. Moreover, the sponsor is only charged for the time interval that the product and service placement is active by tracking the use of the selectable theme, thereby providing the sponsor with more exposure. Accordingly, tracking the amount of time product and service placement is displayed on the selectable theme provides manufacturer with a recurring revenue stream on sold products.

According to one embodiment, the portion 420 may display the remaining of the graphical user interface. For example, various navigatible and selectable icons such as a Settings 422, a TV 424, a Video 426, a Menu 428 and an Info 430 icons, to name a few, may be displayed. It is appreciated that in this exemplary embodiment, since the user has selected a baseball theme, the icons may be configured based on the baseball theme. In this example, the icons 422, 424, 426, 428 and 430 may be configured as a baseball bat and a baseball. It is appreciated that even though icons 422, 424, 426, 428 and 430 have the same configuration, they may have different configurations. Accordingly, in one embodiment, configuration of each icon may differ from another icon. For example, each icon may be a picture of one of the SF Giants players.

In one embodiment, a navigation means such as a pointer or the key arrows of a remote device may be used. However, instead of displaying the pointer as a cursor, the pointer may be configured and customized based on the selected theme. In this example, the selected theme is a baseball theme. As a result, the pointer may be displayed as a still image of a baseball 432 that allows the user to navigate between various navigatible icons (e.g., icons 422, 424, 426, 428 and 430). It is appreciated that in one embodiment, the configured pointer may be animated. For example, the baseball 432 may be animated as a spinning baseball. Upon navigating the baseball 432 over the TV icon 424, a plurality of icons 434 (e.g., channels 1-22) may be displayed. In this exemplary embodiment, the plurality of icons 434 is displayed as a drop down menu. However, it is appreciated that the icons may be displayed in any format, e.g., pop-up window.

Accordingly, the baseball 432 may be used to navigate between different channels. In one embodiment, in response to the baseball 432 navigating between different channels, information related to the plurality of icons 434 may be displayed. In this exemplary embodiment, the baseball 432 navigates to channel 8 and the related information for the channel is displayed in window 436. It is appreciated, that in this embodiment, the content window 436 may be customized based on the selected theme. In this example, since the selected theme is baseball, the content window 436 may be configured to represent a baseball hat. However, it is appreciated that any configuration may be used and the use of a particular configuration should not be construed as limiting the scope of the present invention. It is also appreciated that in one embodiment, the background image and color of the graphical user interface may be configured and customized based on the selected theme. As such, in this example, the background may be a baseball glove.

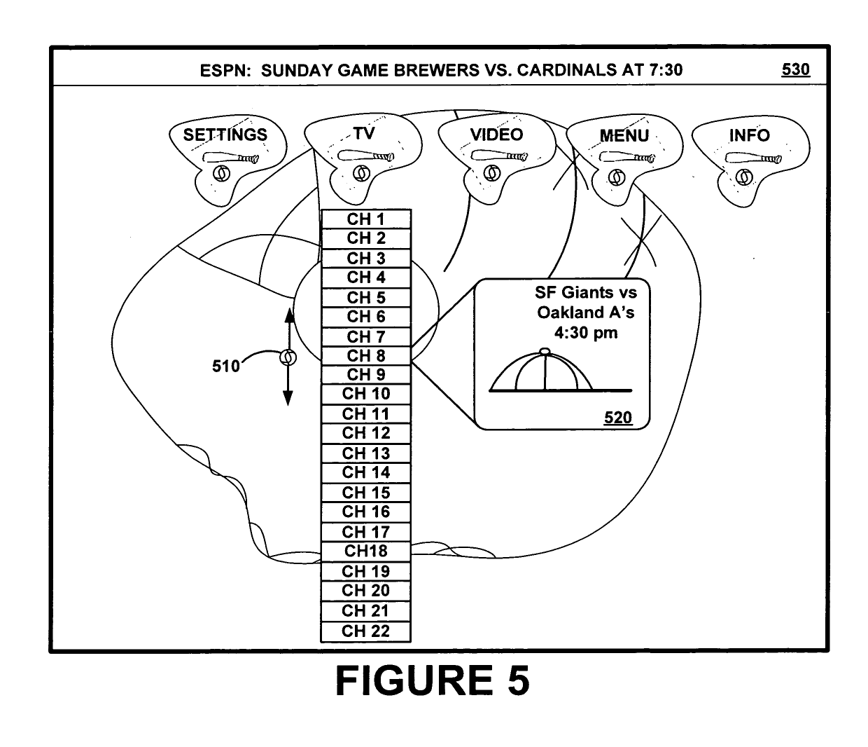

Referring now to FIG. 5, exemplary customized icons during a selection of a selectable item in accordance with one embodiment of the present invention is shown. In this example, the user chooses to watch the baseball game between the San Francisco Giants and the Oakland A's. In response to the selection of this channel, the baseball 432 may change to a baseball bat swinging at a baseball 510. Accordingly, the selection of an icon may be an animation. However, selection of an icon may also be a still image. In one embodiment, selecting the icon may cause the window 520 to be highlighted or animated along with related audio. For example, the window 520 may be animated to show a baseball player throwing his hat on the ground.

It is appreciated that a portion 530 may be used to display advertising. In this exemplary embodiment, the advertising is based on the selected theme. Accordingly, baseball advertising may be displayed since the user is a baseball fan. In one example, the displayed advertising may be a still image or animation. Moreover, the advertising may be new content such as a ticker displaying information and moving in the horizontal direction. For example, the user may be notified that the Brewers versus Cardinals game is on Sunday on ESPN. Accordingly, various advertising information targeted to the user based on the user selectable theme may be displayed in a ticker format and scrolling horizontally.

Accordingly, one or more of the navigatible and selectable icons may be customized in accordance with a user selectable theme. As such, the graphical user interface is now engaging, interesting and based on the user preference. Moreover, the user may be provided with advertising that may be of a particular interest to the user based on the selected theme. Moreover, the cross bar menu may be reconfigured to various TV options, picture viewings, game playing and Internet surfing. In one embodiment, the sponsor for the selected them may be charged for the themeable display for the duration of the time that the theme is used by the user for free. As a result, a means for tracking the duration of the time a given theme is used by a user may be provided. Moreover, using the themeable method and system presented, the revenue generated from the themeable display may be returned to the user as cost saving, thereby encouraging users to purchase the television set with themeable capability. In one example, the generated revenue may be used to reduce the cost of manufacturing the television set.

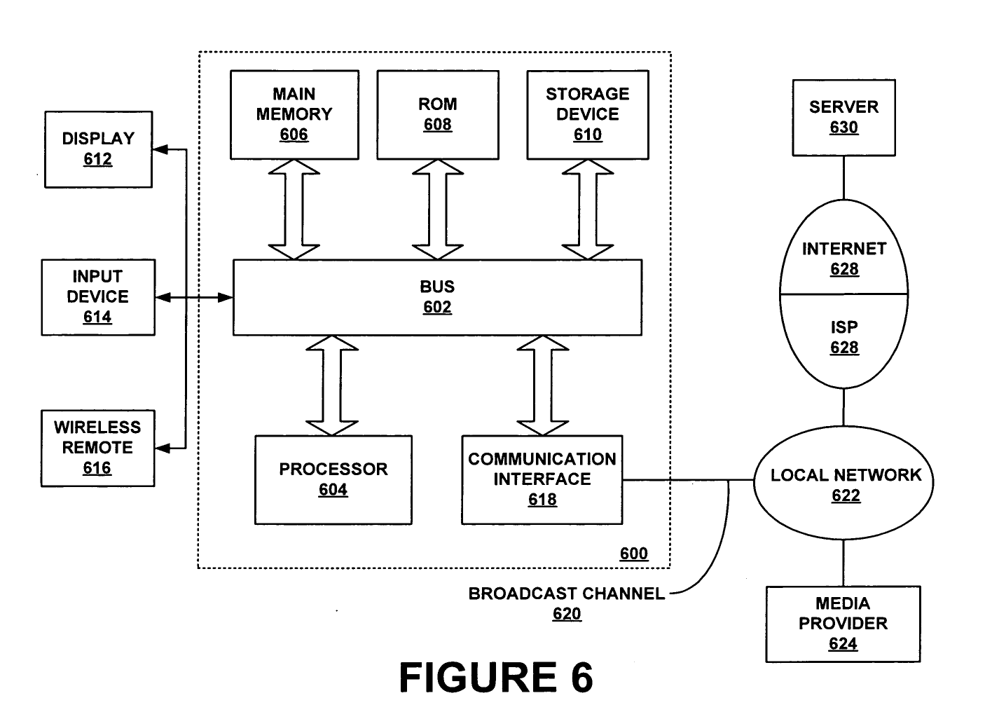

FIG. 6 is a block diagram that illustrates a television system 600 upon which an embodiment of the invention may be implemented. Television system 600 may implement the method 100 as shown in FIG. 1 and includes a bus 602 or other communication mechanism for communicating information, and a processor 604 coupled with bus 602 for processing information. Television system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Television system 600 further includes a read only memory (ROM) 608 or other static storage device coupled to bus 602 for storing static information and instructions for processor 604. A non-volatile storage device 610 is provided and coupled to bus 602 for storing information and instructions and may store the persistent internal queue.

Television system 600 may be coupled via bus 602 to a display 612, such as a cathode ray tube (CRT), for displaying information to a television user. An optional input device 614, including alphanumeric and other keys, may be coupled to bus 602 for communicating information and command selections to processor 604. Another type of user input device is a wireless remote 616 for communicating direction information and command selections to processor 604 and for controlling the operation of various functions/contents on display 612.

The invention is related to the use of television system 600 for customizing the graphical user interface with a selectable theme. According to one embodiment of the invention, the interface is used in response to processor 604 executing one or more sequences of one or more instructions contained in main memory 606 e.g., to implement process 100. Such instructions may be read into main memory 606 from another readable medium, such as storage device 610. Execution of the sequences of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer/television-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio wave and infrared data communications.

Common forms of computer/television-readable media include, for example, a RAM, a PROM, and EPROM, a FLASH-EPROM, any other memory chip or cartridge, a carrier wave as described hereinafter, or any other medium from which a television/computer can read.

Various forms of computer/television readable media may be involved in carrying one or more sequences of one or more instructions to processor 604 for execution. For example, the instructions may initially be carried on a memory component of a computer/television. An infrared detector coupled to bus 602 can receive the data carried in the infrared signal and place the data on bus 602. Bus 602 carries the data to main memory 606, from which processor 604 retrieves and executes the instructions. The instructions received by main memory 606 may optionally be stored on storage device 610 either before or after execution by processor 604.

Television system 600 also includes a communication interface 618 coupled to bus 602. Communication interface 618 provides a two-way data communication coupling to a broadcast channel 620 that is connected to a local network 622. For example, communication interface 618 may be an integrated services digital network (ISDN) card or a modem to provide a data communication connection to a corresponding type of telephone line or it may be through cable services or satellite services. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Broadcast channel 620 typically provides data communication through one or more networks to other data devices. For example, broadcast channel 620 may provide a connection through local network 622 to a media provider 624 or to data equipment operated by an Internet Service Provider (ISP) 626 or provide a connection through cable/satellite services or it may be through a broadcast channel. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on broadcast channel 620 and through communication interface 618, which carry the digital data to and from television system 600, are example forms of carrier waves transporting the information.

Television system 600 can send and receive messages through the network(s), broadcast channel 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of customizing an on-screen graphical display comprising:
providing an identification of plurality of user selectable themes operable to configure said on-screen display;
in response to a selection of one of said plurality of user selectable themes, configuring said on-screen graphical display in accordance with said selected user selectable theme, wherein said configuring is operable to customize content and a plurality of user selectable items within said on-screen graphical display; and
rendering said configured on-screen graphical display for user interaction therewith.

2. A method as described in claim 1 further comprising:
storing said selected user selectable theme.

3. A method as described in claim 1 further comprising:
storing said configured on-screen graphical display.

4. A method as described in claim 1 further comprising:
automatically providing an update for said selected user selectable theme.

5. A method as described in claim 1, wherein said providing is based on determining a user preference in accordance with at least one prior user interaction.

6. A method as described in claim 1 further comprising:
receiving said plurality of user selectable themes.

7. A method as described in claim 1, wherein said plurality of selectable themes is for a television set and said on-screen graphical display is graphical interface.

8. A method as described in claim 1 further comprising:
rendering a sponsor advertising with said configured on-screen graphical display; and
tracking the amount of time said sponsor advertising is displayed to a user of said configured on-screen graphical display.

9. A graphical user interface for customizing an on-screen menu interface comprising:
means for providing an identification of a plurality of user selectable themes operable to configure said on-screen menu interface;
in response to a selection of one of said plurality of user selectable themes, means for configuring said on-screen menu interface in accordance with said selected user selectable theme, wherein said configuring is operable to customize content and a plurality of user selectable items within said on-screen menu interface; and
means for rendering said configured on-screen menu interface.

10. The graphical user interface as described in claim 9 further comprising:
means for storing said selected user selectable theme.

11. The graphical user interface as described in claim 9 further comprising:
means for storing said configured on-screen menu interface.

12. The graphical user interface as described in claim 9 further comprising:
means for automatically providing an update for said selected user selectable theme.

13. The graphical user interface as described in claim 9, wherein said providing is based on determining a user preference in accordance with at least one prior user interaction.

14. The graphical user interface as described in claim 9 further comprising:
means for receiving said plurality of user selectable themes.

15. The graphical user interface as described in claim 9, wherein said plurality of selectable themes is for a television set and wherein said menu interface is a cross bar interface.

16. The graphical user interface as described in claim 9 further comprising:
means for rendering a sponsor advertising with said configured on-screen graphical display; and
means for tracking the amount of time said sponsor advertising is displayed to a user of said configured on-screen graphical display.

17. A graphical user interface system for customizing an on-screen menu display for a television set comprising:
a plurality of rendering blocks operable to configure said on-screen menu display based on a selected user selectable theme, wherein said configuring is operable to customize content and further operable to customize a plurality of navigatible items within said on-screen menu display;
a first portion operable for displaying said customized plurality of navigatible items; and
a second portion operable for displaying said customized content.

18. The graphical user interface system as described in claim 17, wherein at least one of said navigatible items is a selectable item.

19. The graphical user interface system as described in claim 17, wherein said customized content is rendered in response to navigation of said customized plurality of navigatible items.

20. The graphical user interface system as described in claim 19, wherein said customized content is rendered as a pop-up window.

21. The graphical user interface system as described in claim 19, wherein said customized content is rendered as a drop-down menu.

22. The graphical user interface system as described in claim 17, wherein said customized navigatible items comprise animation.

23. The graphical user interface system as described in claim 17, wherein said customized navigatible items comprise still images.

24. The graphical user interface system as described in claim 17 further comprising:
a third rendering portion for displaying advertising information related to said selected user selectable theme.

25. The graphical user interface system as described in claim 17, wherein said selected user selectable theme is automatically updated and automatically customizes content and said plurality of navigatible items within said on-screen menu display.

26. The graphical user interface system as described in claim 17, wherein said configuring is further operable to customize a background of said on-screen menu display based on said selected user selectable theme.
